(19) United States
(12) Patent Application Publication
(10) Pub. No.: US 2010/0000526 A1
(43) Pub. Date: Jan. 7, 2010

(54) OXYGEN SUPPLY DEVICE

(76) Inventor: Wolfgang RITTNER, Siblin (DE)

Correspondence Address: MCGLEW & TUTTLE, PC, P.O. BOX 9227, SCARBOROUGH STATION, SCARBOROUGH, NY, 10510-9227, US

(21) Appl. No.: 11/379,447

(22) Filed: Apr. 20, 2006

(30) Foreign Application Priority Data
Apr. 23, 2005 (DE) 10 2005 019 052.9

(51) Int. Cl. A62B 7/08

(52) U.S. Cl. 128/202.26; 128/204.29

(57) ABSTRACT

An oxygen supply device with at least one oxygen source and with a breathing mask connectable to the oxygen source. An intermediate container is provided, to which the oxygen source may be conductively connected.

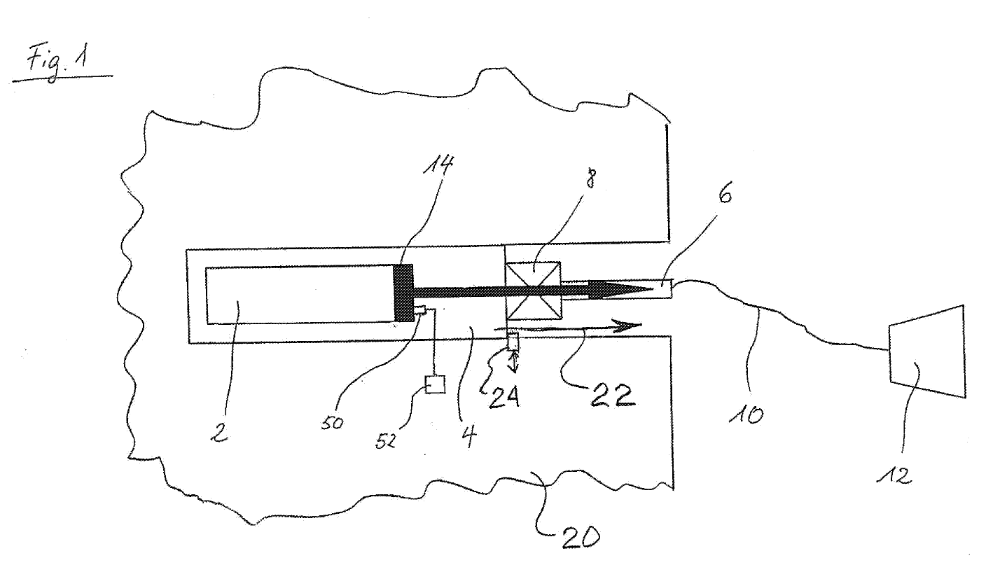

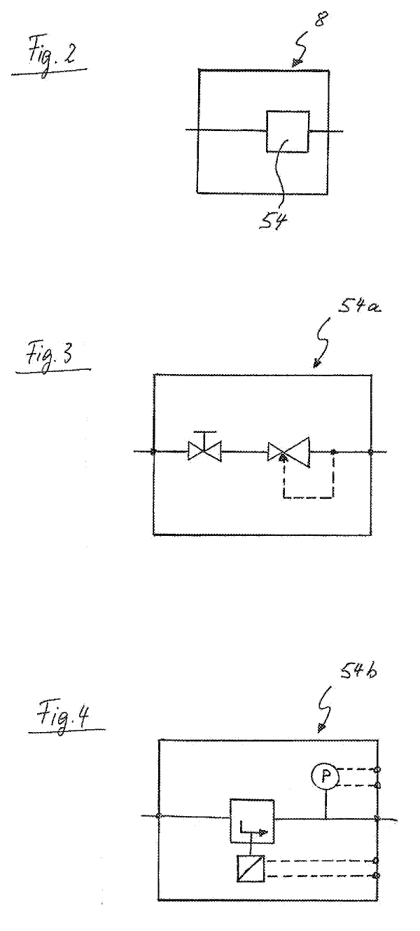

### CROSS REFERENCE TO RELATED APPLICATIONS

This application claims the benefit of priority under 35 U.S.C. § 119 of German Patent Application DE 10 2005 019 052.9 filed Apr. 23, 2005, the entire contents of which are incorporated herein by reference.

### FIELD OF THE INVENTION

The invention relates to an oxygen supply device with at least one oxygen source and with a breathing mask to be connected to the oxygen source for use therewith.

### BACKGROUND OF THE INVENTION

Passenger emergency oxygen systems for aircraft are known, with which oxygen is provided to the passengers in the case of an emergency, which is carried on board an aircraft either in a gaseous manner or a chemically bonded manner. The supply of the oxygen is effected via oxygen masks which are provided for the passengers at their seat locations.

The oxygen as a rule is stored in a gaseous manner in aircraft in central pressurized gas storers. Possible leakages of the pressurized gas storers thereby represent a risk with regard to the availability of oxygen, and thus a risk to safety.

With chemically bonded oxygen, generally no losses in oxygen occur during storage. However, the disadvantage with the use of chemically bonded oxygen is the fact that the release of the oxygen from the chemical bonding and thus the oxygen flow to the oxygen masks as well as the supply pressure to the oxygen masks which this entails, follows in a fixed defined profile. Thus with these systems, it is not possible to control the supply of oxygen in dependence on the cabin pressure.

### SUMMARY OF THE INVENTION

Against this background, it is the object of the invention to provide an oxygen supply device which ensures a reliable oxygen supply and may be simply and inexpensively manufactured and maintained.

According to the invention, an oxygen supply device is provided with at least one oxygen source and with a breathing mask. The breathing mask may be connected to the oxygen source. An intermediate container is provided, to which the oxygen source may be conductively connected.

This arrangement advantageously permits those oxygen sources to which no fittings may be connected at the exit side, said fittings being usual for the closed-loop control of the oxygen pressure and/or of the oxygen flow, to also be able to be used in the oxygen supply device. These fittings are simply arranged at the outlet of the intermediate container, which further advantageously may also be used for presetting the oxygen pressure. The intermediate container is designed in a pressure-tight manner and is arranged within a conductive connection from the oxygen source to the breathing mask. An open oxygen inlet and a closable oxygen outlet are provided on the intermediate container. The usefully initially closed oxygen source is arranged in front of the intermediate container at the entry side of the oxygen inlet. Thus the device according to the invention comprises two closures which are arranged consecutively in a row and which also prevent an undesired exit of the oxygen when one of the closures is not properly closed. The conductive connection between the oxygen source and the intermediate container is created by way of opening the oxygen source. The oxygen may flow out of the oxygen source into the intermediate container, and is collected by this. The breathing mask is connected at the exit side of the intermediate container. After opening the oxygen outlet on the intermediate container, the oxygen is led further to the breathing mask, where it is then made available to the user.

The oxygen source is particularly advantageously arranged in the intermediate container. In this manner, one creates a particularly space-saving design of the oxygen supply device according to the invention. Thereby, the intermediate container is designed as a closed pressurized gas container which for the installation of one or more oxygen sources may be opened and subsequently closed in a pressure-tight manner. One or more breathing masks may be connected to an oxygen outlet of the intermediate container. Advantageously, the intermediate container with this design according to the invention forms a pressure encapsulation for the oxygen source which is therefore particularly protected from possible mechanical loading and damage. A further advantage of this arrangement is the fact that oxygen which exits the oxygen source as a result of a leakage of the oxygen source is collected by the intermediate container. The oxygen which inadvertently flows out is thus not lost, and is available for the passenger in the case of emergency. Accordingly, the reliability of the oxygen supply device is significantly increased with this arrangement.

A pressure regulator dependent on the ambient pressure is usefully arranged downstream of the intermediate container. The pressure regulator serves for the control of the reduced oxygen pressure at the exit side of the intermediate storer. Thereby, the pressure regulator is advantageously designed such that it controls the oxygen pressure present at the oxygen mask depending on the cabin pressure, and for example adapts the oxygen pressure at a great altitude to the oxygen requirement of the user which is increased at this altitude.

In a preferred embodiment of the invention, the oxygen source comprises an integrity closure. The integrity closure is designed such that it closes an outlet opening of the oxygen source in a permanent, gas-tight manner, and prevents an unintentional flow of the oxygen out of the oxygen source. Apart from this, the condition of the integrity closure may serve as an indicator for the operational readiness of the oxygen source, and thus of the oxygen supply device. For example, a damaged or an opened integrity closure provides a hint as to a used or emptied oxygen source. Metal membranes with which outlet openings of oxygen sources may be closed in a pressure-tight manner, but which may be simultaneously opened in an uncomplicated manner, may be used for example as integrity closures.

Means for opening the integrity closure are advantageously provided for this. In the case of the application of the oxygen supply device according to the invention, the conductive connection between the oxygen source and the intermediate container is created with these means, in that an oxygen exit opening on the oxygen source is created or released. Thereby, the means for opening the integrity closure may preferably be designed such that they may either be actuated in an aircraft from a central location, or however may be manually activated in a simple manner by way of the user of the oxygen supply device himself.

In a preferred embodiment of the invention, the oxygen source is designed as a pressurized gas storer with an integrity closure closing the pressurized gas storer in a pressure-tight manner. With this arrangement, a leakage at the pressurized gas storer is prevented on the one hand by the integrity closure which closes the pressurized gas storer in a pressure-tight manner, and on the other hand by way of the intermediate container which collects the oxygen which flows out. For this, it is particularly advantageous to arrange the pressurized gas storer within the intermediate container. The integrity closure is usefully designed such that on the one hand it withstands the filled pressure of the pressurized gas storer, and on the other hand is not complicated to open.

In a further preferred design of the invention, the oxygen source is designed as an oxygen generator for the production of oxygen from at least one chemical releasing oxygen. The oxygen generator after activation releases the oxygen, wherein the flow of released oxygen with respect to time obeys a predefined course which is typical of the oxygen generator. The oxygen which is released from the chemical oxygen generator is subsequently collected by the intermediate container, wherein an oxygen pressure in the intermediate container is built up with an increasing oxygen quantity, which then at the exit side of the intermediate container may be adapted to the breathing requirement, which is dependent on the altitude and the cabin inner pressure, preferably by way of a pressure regulator which is dependent on ambient pressure. The activation of many oxygen generators demands a considerable supply of heat. Additional heat arises by way of the exothermic reaction on release of the oxygen from the chemical. For this reason, it is particularly favorable to arrange the oxygen generator within the intermediate container, so that the intermediate container in this case, on the one hand forms a thermal shielding to the surroundings, and on the other hand forms an increased heat exchange surface, via which the arising heat may be better dissipated.

The oxygen supply device is usefully designed for the selective use of a pressure-encapsulated oxygen source and an oxygen generator. Such a design envisages an intermediate container, with which the pressure-encapsulated oxygen source as well as an oxygen generator may be conductively connected. It is particularly preferable for the oxygen supply device according to the invention to comprise an intermediate container in which a pressure-encapsulated oxygen source as well as an oxygen generator may be selectively arranged.

In particular, for opening the integrity closure of a pressure-encapsuled oxygen source in which the oxygen is stored in a gaseous manner, the means for opening the integrity closure favorably comprise a pin, preferably a hollow pin. The pin serves for piercing the integrity closure, for example a membrane closing the oxygen exit opening. If the pin is designed as a hollow pin, then apart from opening the integrity closure, it may also serve as a defined conduit connection, via which the conduit connection to the intermediate container may be created. Thus the hollow pin may for example be connected to a connection conduit to the intermediate container.

A mechanism for moving the pin in the direction to, and through the integrity closure is provided for opening the integrity closure. This is preferably designed such that it pierces with the pin from a position distanced to the integrity closure of the oxygen source, through the integrity closure in a controlled manner, and here, at the oxygen source, creates an outlet opening for the oxygen. In the case of an oxygen source arranged in the intermediate container, the mechanism is usefully designed such that it may be handled outside the intermediate container.

The oxygen supply device according to the invention on use of an oxygen generator for producing oxygen from at least one chemical releasing oxygen, advantageously comprises means for triggering a reaction releasing oxygen in the oxygen generator. Since the oxygen release with known oxygen generators generally takes its course only at relatively high temperature, it is necessary to lead the heat required for the release of the oxygen to the chemical located in the oxygen generator. Sodium chlorate which is commonly used in chemical oxygen generators for example requires temperatures in a range between 400° and 500° C. in order to break down into NaCl and O₂. Starter cartridges may for example be used as a means for producing these temperatures, which are ignited by way of a priming cap and which produce the appropriate temperatures. An electrical or a mechanic ignition is provided with this. An electrical ignition may be realized for example by way of an electrical resistance heating of a filament. One may further apply ignition systems as are known for example from the ignition or triggering of airbag systems. Mechanical systems may be designed such that an ignition body is moved such that it collides with the primer cap at a sufficient speed and triggers the ignition.

The oxygen supply device is advantageously arranged in a personal service unit in an aircraft. Thus for each passenger of an aircraft, one may arrange an oxygen supply device in the respectively allocated personal service unit, by which means an independent oxygen supply device is provided to each passenger, and one may do away with a central passenger emergency oxygen system with a central oxygen storer and a widely branching conduit system through the whole aircraft which departs from this. The oxygen supply device according to the invention may however also be designed such that it is designed for the oxygen supply to a smaller group of passengers. It is therefore possible for an individual oxygen supply device to be allocated for example to certain seating groups or seat rows in an aircraft.

The oxygen supply device is particularly advantageously designed to be removable from the personal service unit for mobile use. For this, the oxygen supply devices are releasably fixed in the personal service unit. Thereby, the oxygen supply device is arranged in the personal service unit, such that on the one hand an inadvertent falling out is prevented, but on the other hand such that the arrangement permits the oxygen source and the intermediate container which is conductively connected thereto, to be able to removed from the personal service unit and to be inserted again, in an uncomplicated manner. For this, the oxygen source is usefully arranged in the intermediate container, such that only one container is to be removed from, or reapplied into, the personal service unit. This arrangement for example allows a passenger to be able to move freely within the aircraft, for example to go to the toilet, after the removal of the oxygen supply device. The oxygen supply unit may in this manner also be simply removed from the personal service unit and reapplied again for maintenance purposes.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

The invention is hereinafter described by way of one embodiment represented in the drawing. The FIGURE shows a basic sketch of the oxygen supply device according to the invention.

### DESCRIPTION OF THE PREFERRED EMBODIMENTS

Referring to the drawings in particular, an oxygen source 2 is arranged within the intermediate container 4. With regard to the oxygen source 2, it is the case of a pressurized gas container for storing gaseous oxygen. One may alternatively provide a chemical gas generator as an oxygen source 2. The intermediate container 4 is designed in a pressure-tight manner and completely encapsulates the oxygen source 2. An oxygen outlet 6 is provided with fittings 8 on the intermediate container 4. A breathing mask 12 is connected on the oxygen outlet 6 via a supply conduit 10.

The fittings 8 contain a valve for opening and closing the oxygen outlet 6, a flow throttle for controlling the oxygen flow from the intermediate container 4 to the breathing mask 12, as well as a pressure regulator in order to adapt the oxygen pressure to the requirement of the user of the breathing mask 12 in a manner which is dependent on the ambient pressure. The valve which is designed to operate electrically and is also manually actuable, the flow throttle and the pressure regulator are not shown in detail in the FIGURE.

The oxygen source 2 comprises an oxygen outlet which is closed by an integrity closure 14. The integrity closure 14 seals the oxygen source 2 and thus ensures the operating ability of the oxygen source 2. A device which is not shown in the FIGURE is provided for opening the integrity closure. This device is designed such that it may be actuated in an emergency situation in a manual manner, according to design, e.g. by way of pulling a lanyard, electrically, but also in a radio-controlled manner, for example by way of a “wireless LAN” integrated into the aircraft. The device for opening the integrity closure 14 comprises a mechanism which moves an opening tool, preferably a hollow pin, such that this destroys the integrity closure 14 of the oxygen source 2 and thus creates a conductive connection from the oxygen source 2 to the intermediate container 4. If the oxygen source is in this case a pressurized gas storer for storing gaseous oxygen, the gas may then exit from the oxygen source 2 into the intermediate container 4. If the oxygen source 2 is this case an oxygen generator, for producing oxygen from a chemical which releases oxygen, then the device for activating, instead of comprising a means for opening the integrity closure 16, comprises means for activating the chemical reactions which are necessary for releasing the oxygen.

After opening the oxygen source 2, the intermediate container 4 is firstly kept closed, so that the oxygen flowing out of the oxygen source 2 may build up in the intermediate container 4. Thereby a pressure is built up in the intermediate container 4 which is so large that the oxygen may be adjusted downwards by the pressure regulator depending on requirement, after opening the valve of the fittings 8, and is available to the user of the breathing mask 12 in this form. The opening of the oxygen outlet 6 of the intermediate container 4 in the oxygen supply device according to the invention may be effected manually, electrically or by way of “wireless LAN”.

The oxygen supply device is advantageously arranged in a personal service unit 20 in an aircraft. The oxygen supply device is particularly advantageously designed to be removable from the personal service unit 20 for mobile use as indicated by arrow 22. For this, the oxygen supply devices are releasably fixed in the personal service unit by releasing/fixing means 24. Thereby, the oxygen supply device is arranged in the personal service unit, such that on the one hand an inadvertent falling out is prevented, but on the other hand such that the arrangement permits the oxygen source and the intermediate container which is conductively connected thereto, to be able to removed from the personal service unit 20 and to be inserted again, in an uncomplicated manner. This arrangement for example allows a passenger or airplane personnel to be able to move freely within the aircraft, for example to go to the toilet, after the removal of the oxygen supply device. The oxygen supply unit may in this manner also be simply removed from the personal service unit and reapplied again for maintenance purposes.

While specific embodiments of the invention have been shown and described in detail to illustrate the application of the principles of the invention, it will be understood that the invention may be embodied otherwise without departing from such principles.

### APPENDIX

### List of Reference Numerals

2—oxygen source
4—intermediate container
6—oxygen outlet
8—fittings
10—supply conduit
12—breathing mask
14—integrity closure

1. An oxygen supply device comprising:
an oxygen source;
a breathing mask operatively connected to said oxygen source; and
an intermediate container provided to which the oxygen source is conductively connected.

2. An oxygen supply device according to claim 1, wherein the oxygen source is arranged in the intermediate container.

3. An oxygen supply device according to claim 1, wherein a pressure regulator dependent on ambient pressure is arranged downstream of the intermediate container.

4. An oxygen supply device according to claim 1, wherein the oxygen source comprises an integrity closure, and means are provided for opening the integrity closure.

5. An oxygen supply device according to claim 1, wherein the oxygen source comprises a pressurized gas storer with an integrity closure closing the pressurized gas storer in a pressure-tight manner.

6. An oxygen supply device according to claim 1, wherein the oxygen source comprises an oxygen generator for producing oxygen from at least one chemical releasing oxygen.

7. An oxygen supply device according to claim 1, wherein the oxygen supply device is designed for the selective use of a pressure-encapsuled oxygen source or an oxygen generator.

8. An oxygen supply device according to claim 4, wherein the means for opening the integrity closure comprise a pin, wherein a mechanism is provided for moving the pin through the integrity closure.

9. An oxygen supply device according to claim 6, wherein means for triggering a reaction releasing oxygen are provided in the oxygen generator.

10. An oxygen supply device according to claim 1, wherein the oxygen supply device is arranged in a personal service unit in an aircraft.

11. An oxygen supply device according to claim 10, wherein the oxygen supply device is designed removable from the personal service unit for a mobile application.

12. An airplane oxygen supply device comprising:
an intermediate container;
an oxygen source disposed in said intermediate container, said oxygen source including an integrity closure and a means for opening said integrity closure, said integrity closure sealing said oxygen source, said means for opening said integrity closure including a hollow pin, said hollow pin being movable between a non-puncture position and a puncture position, said hollow pin puncturing said integrity closure in said puncture position such that oxygen flows from said oxygen source into said intermediate container; and
a breathing mask operatively connected to said oxygen source via said intermediate container.

13. An oxygen supply device according to claim 12, further comprising:
a pressure regulator connected to said container for regulating gas flow from said container to said breathing mask to adapt the oxygen pressure to the requirement of the user of the breathing mask.

14. (canceled)

15. An oxygen supply device according to claim 12, wherein the oxygen source is a pressurized gas container, said integrity closure closing the pressurized gas container in a pressure-tight manner relative to an interior space of said intermediate container in a closed state.

16. (canceled)

17. An oxygen supply device according to claim 13, wherein the oxygen source is a chemical oxygen generator for producing oxygen from at least one chemical releasing oxygen and said oxygen generator and with an activating means for activating for triggering a reaction releasing oxygen into an interior space of said intermediate container in an open state.

18. An oxygen supply device according to claim 12, wherein the oxygen supply device is removably arranged in a personal service unit in an aircraft.

19. An airplane oxygen supply system comprising:
an oxygen supply device comprising one of a pressure-encapsuled oxygen source and an oxygen generator;
an intermediate container surrounding said oxygen supply device and defining an intermediate space for receiving oxygen from said oxygen supply device;
activating means for activating said oxygen supply device so oxygen flows from said oxygen supply device into said interior space, said activating means including a hollow pin, said pin being mounted for movement such that said pin moves from a first position to a second position, said hollow pin piercing said oxygen supply device in said second position such that said intermediate space receives oxygen from said oxygen supply device when said hollow pin is in said second position, said oxygen supply device being sealed when said hollow pin is in said first position such that said intermediate space does not receive oxygen from said oxygen supply device;
a breathing mask with a supply conduit; and
a pressure regulator connected to said intermediate container and to said supply conduit for regulating gas flow from said intermediate container to said breathing mask to adapt the oxygen pressure to the requirement of the user of the breathing mask, said intermediate container with said oxygen supply device and said activating means being physically connected to said pressure regulator and said breathing mask with supply conduit to form an oxygen supply unit.

20. An oxygen supply system according to claim 19, further comprising:
a personal service unit in an aircraft, said oxygen supply unit being removably arranged in said personal service unit.
